(19) United States
(12) Patent Application Publication
(10) Pub. No.: US 2001/0032520 A1
(43) Pub. Date: Oct. 25, 2001

(54) Method for environmental sampling

(76) Inventor: Michael P. Smith, Tulsa, OK (US)

Correspondence Address: HEAD JOHNSON & KACHIGIAN, 228 W 17TH PLACE, TULSA, OK, 74119, US

(21) Appl. No.: 09/764,501

(22) Filed: Jan. 17, 2001

Related U.S. Application Data
(60) Provisional application No. 60/176,960, filed on Jan. 18, 2000.

(51) Int. Cl. G01N 1/14

(52) U.S. Cl. 73/864.34; 73/864

(57) ABSTRACT

A system and method for collecting a sample of a fluid comprising a sampling apparatus for use in natural or man-made bodies of fluid comprising a polymer-based or metal collection capillary, a capillary filling means attached to said capillary and at least two collapsible sample demarcation indicators affixed to said capillary. The apparatus of the instant invention is deployed by first inserting a polymer-based or metal collection capillary below the surface of the fluid body from which a sample is to be withdrawn then filling the capillary using the capillary filling means, monitoring the flow of fluid from the fluid body to the internal chamber of the submerged collection capillary and then causing the cessation of said flow.

### REFERENCE TO PENDING APPLICATIONS

This application is related to Provisional Patent Application 60/176,960, filed on Jan. 18, 2000 and entitled “Method For Environmental Sampling”.

### REFERENCE TO MICROFICHE APPENDIX

This application is not referenced in any microfiche appendix.

### TECHNICAL FIELD OF THE INVENTION

In general, the present invention relates to an apparatus and method for collecting a sample of a fluid. In particular, the present invention relates to a method and apparatus for use in collecting samples of fluids within natural or man-made bodies via a capillary filling means attached to a polymer-based or metal collection capillary.

### BACKGROUND OF THE INVENTION

The method and apparatus of the instant invention has many advantages over current methods of collecting environmental samples. Current methods are expensive, require special handling and shipping, and the sample rapidly deteriorates. The invention proposed herein does not suffer from these disadvantages.

Other existing sampling techniques often require the shipment of rather large samples packed in ice to prevent deterioration and samples are also usually shipped in glass bottles, which can easily break. These samples usually require the components of interest be concentrated by expensive and complicated extraction techniques before the sample can be analyzed for the suspected contaminants.

The invention described here does not suffer from these problems. The invention's polymer based or metal capillaries are very small and easily adapted for shipping. Polymer based capillaries, metal capillaries, and capillaries of other materials used in alternative embodiments of the instant invention, will not break during shipping. After the capillary is filled with fluid, and sealed by crimping, plugging or other sealing means, the sealed capillary can be heated to a temperature near or above boiling to destroy any organisms within the sample, and thus preserve the sample from deterioration indefinitely.

The invention described here does not require any extraction of the contaminants prior to analyses. Because of the small volume of the actual sample, the entire sample can be input directly into the analytical apparatus, usually a mass spectrometer (i.e., MS), or a gas chromatogram (i.e. GC), a GC/MS, or some other instrument. The ability to directly analyze these samples using a mass spectrometer greatly reduces the analyses time and cost. If analyzed using a mass spectrometer, the tube can be opened under vacuum. Time and cost are reduced both in the analyses of the sampling, as well as in the taking, preserving, and shipping of the sample.

### BRIEF SUMMARY OF THE INVENTION

This invention is an improved method and apparatus for taking environmental samples of fluid. These fluids can be any gas or liquid. The method involves collecting the sample in a capillary tube. The tube is preferably polymer based or metal but tubes made of other materials may be used. The tube is filled with the fluid by use of a syringe means, bulb means, funnel means or other filling means. After filling, the tube is hermetically sealed, preferably by crimping, although some other means, such as a plugging via a compression fitting could be used to seal the tube. The integrity of the fluid in the tube may be further protected against deterioration by heating. The sealed sample is subsequently shipped to the analytical facility without the need of special expensive containers or ice or other preservatives, although use of preservatives is possible, and the sampled fluid is released directly into the analytical apparatus or sample preparation means by using an opening means to rupture the tube.

The capillary is attached to a capillary filling means, such as a polymer based repeatedly collapsible bulb device, the end of a syringe or a funnel. The capillary can be filled by using the bulb or syringe to pull the fluid sample into the capillary. In this method the capillary would function as the needle on a syringe or the capillary can be filled by draining sample out of a funnel into the capillary. Other means can also be used to fill the capillary with the fluid, these include but are not limited to mechanical pumping, forced insertion such as by squeezing a tube of fluid attached to the capillary, passive displacement of the gas, liquid, or soluble solid already in the capillary, or other means.

Once the capillary is filled it can be hermetically sealed by the preferred means of crimping, or some other means such as welding, glueing, epoxying, plugging, attaching compression fittings or other sealing means. Crimping allows the sample to be sealed at a number of different locations along a single capillary tube, allowing multiple samples to be taken from one capillary, and more completely ensuring the integrity of the innermost sample. Multiple samples made by multiple crimps on a single capillary can be separated by simply cutting the tube into segments between crimps.

In yet another alternative embodiment an automated system could be used to capture samples of various fluids at various times into numerous capillaries. The automated system could then also seal the capillaries, and preserve by heating if necessary.

An object of the instant invention is to be used for the sampling of any type of fluid, either gas or liquid, and then can be used with any type of analytical apparatus.

An important object of the present invention is to avoid the expense and special handling and shipping attendant to prior art sampling methods and apparatuses.

A further object of the instant invention is to avoid the rapid deterioration of fluid samples.

Yet another object of the instant invention is to avoid the collections of samples which are subsequently shipped in glass bottles which easily break.

A further object of the instant invention is to avoid the requirement that components of interest must be concentrated by expensive and complicated extraction techniques before the sample can be analyzed for any suspected contaminants.

Yet another object of the instant invention is to require the extraction of any contaminants prior to analyzing a collected sample.

A further object of the instant invention is to provide a collection capillary which can be inlet directly into an analytical apparatus such as but not limited to a mass spectrometer (MS), a gas chromatogram (GC), a GC/MS, or some other instrument. dr

Other objects and further scope of the applicability of the present invention will become apparent from the detailed description to follow, taken in conjunction with the accompanying drawings wherein like parts are designated by like reference numerals.

### DESCRIPTION OF THE DRAWINGS

FIG. 1 illustrates an open collection capillary that can be used in conjunction with the invention as practiced in its preferred embodiment.

FIG. 2 further illustrates additional detail of a capillary collection tube as used in conjunction with the instant invention when practiced in its preferred embodiment providing clarity with respect to the positioning of demarcation indicators which can be crimped to allow multiple samples to be taken within one capillary tube.

FIG. 3 illustrates the invention as practiced in its preferred embodiment further illustrating the capillary collection tube affixed to the instant invention.

FIG. 4 illustrates the practice of the instant invention when utilizing a funnel as a capillary filling means.

### DETAILED DESCRIPTION OF THE PREFERRED EMBODIMENTS

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the present invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

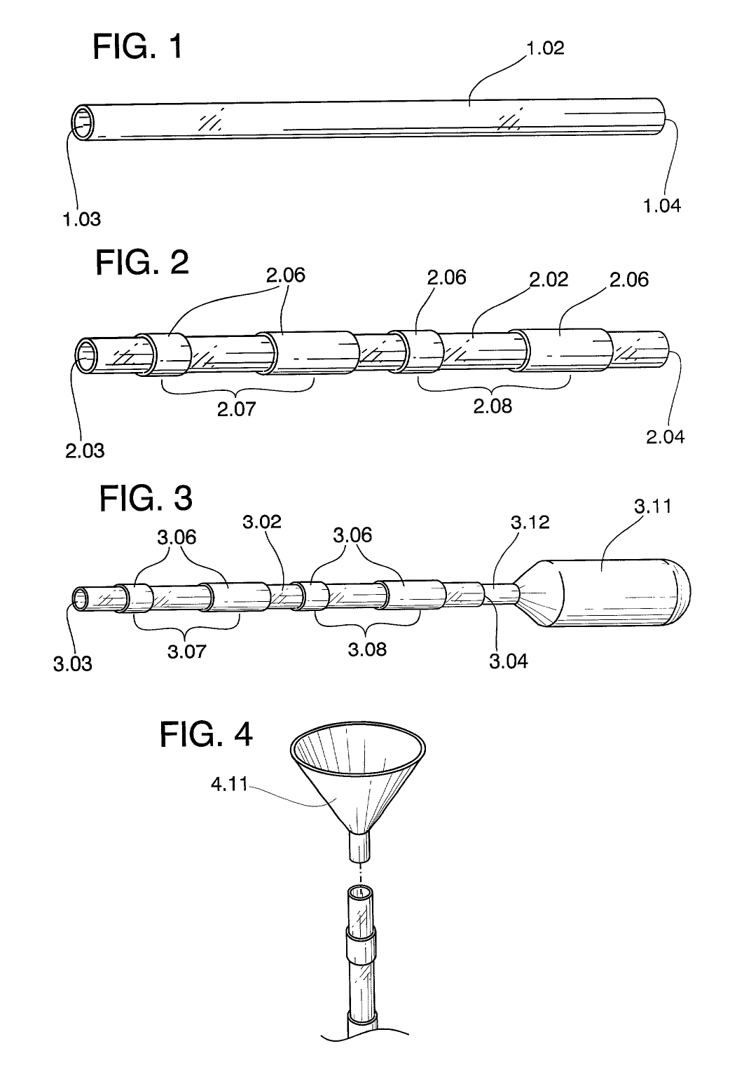

FIG. 1 illustrates an open collection capillary that can be used in conjunction with the invention as practiced in its preferred embodiments. Turning now to FIG. 1.

As practiced in its preferred embodiment, the capillary 1.02 of the instant invention consists of a polymer based material or metal such as but not limited to Teflon. In field testing it has been shown that the capillary of the instant invention is most effectively practiced by utilizing a first end 1.03 and second open end 1.04. The outside diameters of the invention's capillary 1.02 as practiced in its preferred embodiment is approximate 1/16″ with an internal chamber of approximately 5/100″ to 8.5/100″ diameter transversing the length of the capillary 1.02 although this can be varied to accommodate any desired sampling requirement. As practiced in the preferred embodiment, the length of the capillary is approximately 2″ though varying accommodation and sizing may be implemented to coincide with any unique application and analysis requirements.

FIG. 2 is an illustration which provides additional detail of a capillary collection tube as used in conjunction with the instant invention when practiced in its preferred embodiment providing further clarity with respect to the positioning and demarcation indicators which can be crimped to allow for multiple samples to be taken within one capillary tube. Turning now to FIG. 2.

As can be seen in FIG. 2, the capillary of the instant invention 2.02 illustrates the isolation of two samples 2.07 and 2.08 within the capillary 2.02. The samples are segregated by sealing each sample from the other via the crimping of demarcation indicators 2.06 located strategically along the length of the capillary tube 2.02. Said crimping demarcation indicators in the invention's preferred embodiment are comprised of a collapsible metal, such as but not limited to copper, brass, aluminum or any other composition allowing for the adequate sealing and segregation of multiple collected samples within the capillary 2.02. As illustrated in FIG. 2 the capillary 2.02 is capable of containing and segregating two distinct samples 2.07 and 2.08. It is clear given such disclosure that greater or lesser numbers of samples may be had merely by increasing the length of the tube and/or number of crimping indicators.

FIG. 3 illustrates the invention as practiced in its preferred embodiment further illustrating the capillary collection tube affixed to the filling means of the instant invention. Turning now to FIG. 3.

In FIG. 3 the capillary 3.02 is attached to the capillary filling means 3.11 by insertion of the filling means 3.1 1 into internal chamber of the capillary tube 3.02. It is clear given the benefit of the instant disclosure that such an attachment affixation may be had by reversing such positions and allowing the capillary tube to be inserted within a properly sized capillary filling means internal chamber 3.12. Though, through extensive testing it has been found the most effective manner in which to practice the instant invention is the embodiment as illustrated in FIG. 3. FIG. 3 also illustrates the first open end of the instant invention's capillary 3.03, collapsible demarcation indicators 3.06 and the relative positioning of at least two collected samples 3.07 and 3.08.

To effectuate the collection of a sample using the apparatus of the instant invention, the sample is garnered by inserting the polymer based collection capillary of the instant invention below the surface of a fluid body from which a sample is to be withdrawn manipulating a capillary filling means attached said capillary in a manner sufficient to introduce the fluid into the internal chamber of the capillary and then monitoring the flow of fluid from said fluid body to the internal chamber of said submerged collection capillary, and causing the cessation of said fluid flow. The cessation of the fluid flow is typical though not necessarily participated by withdrawing the submerged collection capillary from the fluid body. Once collected, the sample or samples are sealed for subsequent analysis by the crimping of a plurality of collapsible demarcation indicators. The demarcation indicators are typically located surrounding the outside diameter of the capillary though in an alternative embodiment, such crimping indicators could be less effectively practiced by locating them within the internal chamber of said capillary.

Though the practice of the instant invention is most effectively had by a capillary filling means such as repeatedly collapsible bulb, it is easily envisioned having the benefit of the instant disclosure that the capillary could be affixed to a syringe to allow for the withdraw of the fluid to within the internal confines of the capillary, or affixed to a funnel to allow the capillary to be filled by gravity flow.

FIG. 4 illustrates an alternative embodiment of the instant invention utilizing a funnel 4.11 as a capillary filling means.

From the foregoing description, it will be appreciated that numerous modifications may be made of this invention without departing from its spirit. Therefore, there is no intention to limit the scope of this invention to the specific embodiments illustrated and described. Rather, it is intended that the appended claims and their equivalents determine the scope of this invention.

Other objects and further scope of the applicability of the present invention will become apparent from the detailed description to follow, taken in conjunction with the accompanying drawings wherein like parts are designated by like reference numerals.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

What is claimed is:

1. A sampling apparatus for use in natural or man-made bodies of fluid comprising:
a polymer based or metal collection capillary;
a capillary filling means attached to said capillary; and
at least two collapsible sample demarcation indicators affixed to said capillary.

2. The sampling apparatus of claim 1 wherein said capillary is further defined as being capable of submerging below the surface of said fluid.

3. The sampling apparatus of claim 1 wherein said capillary is constructed of a Teflon based polymer.

4. The sampling apparatus of claim 1 wherein said capillary filling means is a collapsible bulb.

5. The sampling apparatus of claim 1 wherein said capillary filling means is a syringe.

6. The sampling apparatus of claim 1 wherein said capillary filling means is a funnel.

7. The sampling apparatus of claim 1 wherein said collapsible sample demarcation indicators are positioned around the exterior surface of said capillary.

8. The sampling apparatus of claim 1 wherein said collapsible sample demarcation indicators are positioned within the interior of said capillary.

9. A method for collecting a sample of a fluid comprising:
inserting a polymer based collection capillary below the surface of a fluid body from which a sample is to be withdrawn;
manipulating a capillary filling means attached to said capillary in a manner sufficient to introduce the fluid into the internal chamber of said capillary;
monitoring the flow of fluid from said fluid body to the internal chamber of said submerged collection capillary; and
causing the cessation said fluid flow.

10. The method of claim 9 wherein said cessation is precipitated by withdrawing said submerged collection capillary from said fluid body.

11. The method of claim 9 wherein said cessation is precipitated via the purging of negative pressure within the internal chamber of said submerged collection capillary.

12. The method of claim 9 wherein said cessation is caused by crimping the tubes.

13. The method of claim 9 further comprising the crimping of a plurality of collapsible sample demarcation indicators to seal fluid residing within the internal chamber of said collection capillary.

14. The method of claim 9 further comprising the insertion of said capillary containing said fluid into an analytical apparatus.

15. The method of claim 9 wherein said cessation is caused by glueing the tubes shut.

16. The method of claim 9 wherein said cessation is caused by epoxying the tubes shut.

17. The method of claim 9 wherein said cessation is caused by plugging the tubes shut.

18. The method of claim 9 wherein said cessation is caused by attaching compression fittings to the end of the tubes.
